(19) United States
(12) Patent Application Publication
(10) Pub. No.: US 2009/0018943 A1
(43) Pub. Date: Jan. 15, 2009

(54) web based technology system and method for the marketing of online quotations and offers to consumers and businesses looking to acquire products or services, where a consumer or business is able to register his requirements once and publish them anonymously to any product or service provider, regardless of whether they have a website, who may wish to provide a quotation for providing that product or service.

(76) Inventor: Manjit Rana, Nottingham (GB)

Correspondence Address: Mr Manjit Rana, 6, Longlands Drive, West Bridgford, Nottingham, NG2 6SR, GB

(21) Appl. No.: 11/778,028

(22) Filed: Jul. 14, 2007

(51) Int. Cl. G06Q 40/00

(52) U.S. Cl. 705/37

(57) ABSTRACT

The quotes2me service uses the concept of “e-wallets” to flip the existing processes that a consumer or business goes through to acquire a product or service, instead of using several channels such as physical stores, call centres, directories, search engines or price comparison sites to source and negotiate the best deal for a product or service the consumer can register his “requirements” into a web based form which is then anonymously published into a Quote Opportunities database. Product or service providers are able to select Quote Opportunities and register their best quotation or offer against them. Consumers compare the offers received and are connected to the Quote Provider that they wish to purchase from.

e-wallets are branded and distributed by partner organizations who receive the additional benefits of being able to see the cheapest price in their e-wallets for any products or services that they quote for and receive a share of the revenue generated by their e-wallets.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Consumers or businesses looking to acquire a product or service often use multiple channels to obtain competitive prices which may include physically visiting supplier's stores, locking for potential suppliers using telephone directories, using call centres, search engines and price comparison sites. In short this is often a very time consuming, frustrating and confusing process. There is currently no way for a consumer (the Buyer) to provide his “requirements” once into a centralized environment and have any potential suppliers from across the whole market regardless of their preferred marketing channels, notify the buyer of what they have to offer. The quotes2me platform and business process sets out to rectify this deficiency in the marketing/sales/purchasing cycle. A key differential between the quotes2me service and existing price comparison services is that with the quotes2me service a product or service provider does not need to have even a basic website to use the service to provide quotations and offers to consumers which effectively opens the service to the whole market and is not limited to just those product providers that have an online interactive or automated quotes service.

### BRIEF SUMMARY OF THE INVENTION

The quotes2me platform and method provides a market solution and in summary provides functionality and benefits to:
(a) Consumers (and businesses) who are looking to acquire a commoditised product or service referred to here as the buyers,
(b) Product retailer, distributors and service providers (sellers) referred to here as the Quote Providers and
(c) Retail or consumer facing brands which may include product distributors, retailers, service providers and charitable organizations which are referred to generically here as the brands.

The Buyers—the quotes2me technology platform enables a buyer, following a secure registration process, to record and anonymously publish their requirements for a particular product or service, that they are looking to acquire, using secure online forms that are grouped together into a personalised “e-wallet”. Individual, anonymised, requirements are referred to as Quote Opportunities can be linked back to the buyers contact details using unique identifiers once the buyer has selected a Quote Provider that they would like to purchase from or at least exchange contact details with.

The Quote Providers—The Quote Providers are able to login, following a secure registration process, to the quotes2me service and using the filtering and segmentation faculties, identify specific Quote Opportunities that they may be interested in responding to with an offer. The Quote Providers are charged a small transaction fee for each Quote Opportunity that they access full details for. The Quote Providers may register their quotation or offer using a variety of interfaces which range from direct entry via the direct-entry screens on the quotes2me service, batch entry using a spreadsheet download/upload facility and integrated access using an XML or web services interface.

The buyers are then able to subsequently log back into their personalized e-wallet held on the quotes2me service to view and compare the selection of quotations/offers received for their specific requirements. The buyer is then free to use the quotes2me service to be connected to one or many of the Quote Providers or may decide to use the information to approach an alternative supplier directly. Quote Providers are charged a transaction fee for each Quote Opportunity they access which effectively generates a revenue stream for each e-wallet. The revenue stream is owned by quotes2me but may be shared with other partners. For example if Buyer A decides to register his requirement for a Sony 42″ LCD television which is selected by ten Quote Providers who all pay $1 to register their best offer, Buyer A's e-wallet has derived a revenue of $10 which is payable to the quotes2me service.

The quotes2me service is a “white label” platform that can have any branding applied to its interfaces dynamically applied as a result of the login details. This enables retail or consumer facing brands to distribute e-wallets under their own brand to their customers or prospects. In this instance they are able to share the quotes2me revenue stream generated by their branded e-wallets—effectively providing them with a revenue stream as their customers and prospects use the service to shop around for products or services—which they may or may not offer themselves. One additional benefit brands receive for distributing the e-wallets is that they get to see the cheapest quotation registered for each Quote Opportunity that they decide to quote on, in their consumer's e-wallet, enabling them to provide a better offer should they wish to do so. No other Quote Provider gets access to this information and no other Quote Provider is able to see the branding associated with any Quote Opportunity.

### BRIEF DESCRIPTION OF THE SEVERAL VIEWS

Not Applicable

### DETAILED DESCRIPTION OF THE INVENTION

1. Buyer Registration Process—Buyers (which can be consumers or businesses) are made aware of the service through a variety of marketing campaigns—if the marketing campaign is conducted by a Brand partner they are able to issue a promotion code which, when entered on the registration page, determines the branding on the Buyers e-wallet service. The Buyer creates a secure e-wallet account and registers his personal contact details and service preferences which determine how the quotes2me service interacts with the e-wallet owner.
2. Requirement registration—Following a login to his e-wallet account the buyer is able to register his specific requirement by selecting the appropriate requirement input form from the template library which allows the buyer to record the relevant details required by Quote Providers to respond by registering their quotes and/or offers. A completed requirements form is known as a Quote Opportunity. The Buyer may be as specific or brief as he decides in recording his requirement. For example—the requirement may be defined as a “Sony 42″ LCD television”, just a “42″ screen television”, a “Sony television” or a “42″ LCD television”, depending on what was most important.
3. The requirement details are validated on entry and the Buyer is asked to enter a date by which he expects to make a buying decision and hence the deadline for receiving quotes and offers. In the case of insurance requirements, if the Buyer registers his current policies, the service will automatically use the expiry date of his current policy as the deadline for receiving quotes.
4. The quotes2me platform then creates a Quote Opportunity record which consists of all data required by the Quote Provider to provide a quotation without divulging any contact details—this ensures that the Buyer can not be contacted directly through any other means except via the quotes2me service.
5. The buyer is then able to move onto registering another requirement or logging off from the service.
6. Specifically for insurance the service offers the functionality to enable the buyer to use the quotes2me service to record and manage his portfolio of insurance policies regardless of whether they were bought through the quotes2me service or not—in this instance the service provides a “one stop shop” for managing their policies and the renewal/re-quote process—eliminating the need to shop around using venous call centres, high street intermediaries, quote aggregators and insurance distributor websites.
7. Potential Quote Provider's first have to register their interest in using the quotes2me service by providing appropriate company details and fulfilling other validation requirements. Following a validation process, a secure account will be created for them to access the database of Quote Opportunities. The registration process enables the Quote Provider to register specific details such as business background which the Buyer may review before making a selection. The registration process also sets up the operational preferences which determine how the Quote Provider plans to use the quotes2me platform to source and respond to Quote Opportunities.
8. A Quote Provider logs into the service and selects the product or service type that he is looking to provide quotes for. The quotes2me platform makes the Quote Provider aware of the number of Quote Opportunities available for that product or service type that are requiring a quote within a defined period. The Quote Provider is then able to further segment the Quote Opportunity database using the available filtering and segmentation tools.
9. Each Quote Opportunity type has an associated quote cost which in the example of the Sony television may be $1. Each Quote Opportunity type can also have volume purchasing discount bands—ie the first 100 Quote Opportunities for televisions may be priced at $1, the next 50 bought that month may be $0.90 and anything over 150 Quote Opportunities bought that month may be discounted to $0.80.
10. Once the Quote Provider has selected the range of Quote Opportunities that he is interested in having a more detailed look at, the quotes2me service calculates and displays the total cost of accessing the selected group of Quote Opportunities. The Quote Provider is then asked to verify that they are aware of the transaction cost following which the full Quote Opportunity details are made available using a variety of interfaces;
   a. A summary of the Quote Opportunities is displayed on the Quote Providers web-browser with a facility to drill down to view the full requirement details of each Quote Opportunity. The Quote Provider is then able to register details of their quotation or offer which may include Product manufacturer details, product specifics, delivery details and any “offer” details such as “buy from us receive a free Sony DVD player” or “free delivery as you are within 5 miles of our retail store” or “we are able to offer a 50″ Hitachi plasma screen television with two years free warranty for less than the typical price of a Sony 42″ model” (this allows Quote Providers to make the consumer aware of suitable alternatives that they may not have previously considered;
   b. The method described in 10a may be provided as a offline process where all the Quote Opportunity details are exported into a spreadsheet which can be downloaded by the Quote Provider, each record can then be appended with the quotation or offer details and uploaded back into the quotes2me service—which then validates the information received and registers the quotation or offer details against the appropriate Quote Opportunity records.
   c. For high volume users the quotes2me service can be integrated with the product or service providers' in-house technology platform using XML or web services interfaces.
11. A Quote Provider may also set up “alerts” that can provide an email or mobile text message (SMS) notification to the Quote Provider (once a day or each time a Quote Opportunity is registered that meets the alert criteria). Email based alert messages contain a hyperlink that takes the Quote Provider directly to the pre-segmented list of Quote Opportunities which can then be further segmented, selected and quoted against as described in point 10 above.
12. Quotation and/or offer details are validated and allocated against the specific Buyers requirements record in their personal e-wallet.
13. The buyer is then able to log back into his e-wallet to review and compare quotes and otters at his leisure.
14. The buyer can either use the information to contact one of the listed Quote Providers directly or be connected to the Quote Providers online or phone based ordering system (dependent on the sophistication of the Quote Providers technology platform as detailed by the Quote Provider at registration time).
15. As no commission or success fee is charged by the quotes2me service the price quoted for the product or service should be the same as if the buyer had contacted the Quote Provider directly—which is often not the case when dealing with most of the existing price aggregation services.
16. If Buyer A registers his requirement for a Sony 42″ LCD television and ten Quote Providers register an offer or quotation paying $1 each, Buyer A's e-wallet generates revenue from that requirement of $10 for the quotes2me service.
17. Buyer A's e-wallet generates revenue from each requirement that is registered and if the products registered are annually renewable contracts such as insurance or mobile phone contracts, assuming quote providers provide a quote on renewal, the e-wallet generates revenue each year regardless of whether the buyer ultimately decides to move his policies to another insurance provider or not.
18. The quotes2me technology platform has been designed so that the screens can be dynamically branded with the appropriate logos, colours, language, currency etc. which is determined by the user-id at login. This provides an option for the quotes2me service to be offered to a group of people by a partner organization under their brand. They effectively encourage their clients or prospects to register for a branded e-wallet. The revenue generated by the e-wallets carrying that brand can then be shared with that partner organization.
19. Only the registered e-wallet owner (Buyer) and the brand owner of that e-wallet is able to determine the branding on those e-wallets and their associated Quote Opportunities—no one else is therefore able to see which brand is associated with a Quote Opportunity that they may be registering a quotation or offer against. This is designed to prevent the deliberate targeting of a particular brands e-wallets.
20. An additional benefit to a brand distributing e-wallets is that they are able to see the cheapest quotation registered in the e-wallets issued by them for any Quote Opportunities that they choose to quote against. This enables them to improve their chances of winning the business for products or services that they went to market to the e-wallet owner—ie The e-wallet was provided to Buyer A by Wal-Mart and Buyer A decides to register his requirement for a new Sony 42″ LCD television. Wal-Mart selects Buyer A's Quote Opportunity to quote against. Wal-Mart is able to see the cheapest deal currently registered by other Quote Providers. None of the other Quote Providers are aware that Buyer A's e-wallet was provided by Wal-Mart and as a result they could potentially be undercut, the e-wallet may have been offered to the consumer by their insurance provider who would have no interest in quoting for televisions. Quote Providers can however offer bundled deals which Wal-Mart would not see the specific details of as they only get to see the cheapest priced quotation or offer. Wal-Mart also does not know which Quote Provider had provided the cheapest quotation—only the price quoted. If Wal-Mart decides to register a quotation and another Quotation Provider subsequently registers a cheaper quotation, Wal-Mart are notified by email and are given the opportunity to revise their quotation.
21. For products such as motor Insurance policies the facility described in point 20 enables an insurance quote provider to dramatically improve their quote conversion ratio and improve their renewal retention by being able to identify those policy holders that they are likely to lose to a competitor BEFORE the renewal date. If, in this instance, Wal-Mart decides not to quote a cheaper price for the motor insurance they would still generate revenue as a result of other Quote Providers registering quotations or offers into the Buyers e-wallet.
22. A consumer may only have one e-wallet account, it is therefore in the interest of a brand to issue e-wallets to their clients/prospects before someone else does and gains the additional benefits of improving their chance of winning business and of receiving a share of the revenue stream.

I claim:

1. The creation of an “e-wallet” which comprises of a series of web based data capture forms used to record one or more “requirements” for a particular consumer or business who is looking to source products or services.

2. The process of taking the e-wallet as defined in claim 1, separating the e-wallet owners contact details from the data describing the specific requirement registered (Quote Opportunity) and adding it to a database of anonymised Quote Opportunities.

3. Making the database of Quote Opportunities, as described in claim 2, available to any product or service provider (Quote Provider), regardless of whether the Quote Provider has a website for marketing his products or services or not, over the internet or a mobile telecommunications network, who may be interested in electronically registering an offer or price based quotation against that specific requirement.

4. Provide the means by which Quote Providers can search, filter, segment and select specific Quote Opportunities from the database of Quote Opportunities, as described in claim 2, in order view the full requirement details and potentially register an offer or price quotation against.

5. Creating a financial transaction to charge the Quote Provider a transaction fee for registering their offer, either in advance or subsequently, for any Quote Opportunities selected and the details being made available to the Quote Provider or his representative or agent from the Quote Opportunities database as described in claim 2.

6. The selection of Quote Opportunities for a specific product or solution and being able to register a suitable alternative product or service—ie offering an Hitachi television to someone looking for a Sony television.

7. The registration of the offer or price quotation by the Quote Provider against each selected Quote Opportunity which may include “features/benefits” of the product, service or Quote Provider through entering data into a text box which subsequently appears in the consumer's e-wallet when he reviews the offers received.

8. The using of the e-wallet by the consumer to manage his insurance portfolio regardless of whom he purchases the specific policies from or through and as a result providing a single environment with all the risk details and policy management details required to manage each of those policies either individually or as a portfolio.

9. The creation of “alerts”, which are set up by a Quote Provider, to automatically notify him by email or mobile text message of any new Quote Opportunities registered into the system that meet the pre-defined parameters of the alert, i.e. A Quote Provider may create an alert that notifies him each time someone creates a Quote Opportunity for a 32″ Sony LCD Television or each time a Quote Opportunity is registered for a 32″ LCD television regardless of the manufacturer.

10. Providing the mechanism for partner organizations to offer “branded e-wallets” to their client and prospect bases with their own branding.

11. The branding, which may include the application of specific logos, colours, buttons, and banner adverts on branded e-wallets as in claim 10 is dynamically applied to the e-wallet interfaces and are determined by the login credentials of the e-wallet owner.

12. A mechanism and process which allows a branded e-wallet provider as described in claim 10 to view the cheapest quote from the range of quotes offered by the other Quote Providers.

13. Should the branded e-wallet provider, as described in claim 10, select a Quote Opportunity from one of the e-wallets issued by him and then register a price quotation or offer against the Quote Opportunity, a mechanism and process will automatically alert the trended e-wallet provider, by email or text message, when another Quote Provider registers a price quotation against the same Quote Opportunity thereby enabling the branded e-wallet provider to re-submit an improved offer or price quotation.

14. A process electronically gathers all price quotations and offers as they are registered by the Quote Providers and presents them to the e-wallet owner enabling him to review and compare them at his leisure.

15. At no point during the price quotation and offer gathering process does the system divulge details of which brand has issued the e-wallet to the consumer or business.

16. At no point does the system share details of the price quotations or offers registered against specific Quote Opportunities apart from making the branded e-wallet provider aware of the cheapest quotation or offer registered in e-wallets supplied by them but even in this instance only the price is published not details of what the offer includes nor which Quote Provider registered it.

17. At the point where the e-wallet owner selects one or more Quote Providers from his summary screen to purchase the product or service from, the systems “connects” the e-wallet owner and the Quote Provider in one of a number of ways depending on the level of sophistication of the Quote Providers sales systems;
a. the contact details and a reference number is displayed on the e-wallet owners screen for the Quote Provider and the Quote Provider receives an email or text message with the e-wallet holders name and contact details or;
b. the service connects to the Quote Providers website via a web-link and passes the data registered in the Quote Opportunity over to the Quote Providers web service allowing the consumer to complete the transaction via the Quote Providers website or;
c. the service passes the data in the Quote Opportunity record to the Quote Provider via an XML data feed or web-service enabling the Quote Provider to manage the completion of the transaction.
